(19) United States
(12) Patent Application Publication
(10) Pub. No.: US 2021/0287647 A1
(43) Pub. Date: Sep. 16, 2021

(54) HI-HAT CONTROLLERS AND PEDAL ACCESSORIES

(71) Applicant: Rare Earth Dynamics, Inc., Radcliff, KY (US)

(72) Inventor: Stephen Riley Suitor, Radcliff, KY (US)

(73) Assignee: Rare Earth Dynamics, Inc., Radcliff, KY (US)

(21) Appl. No.: 17/182,205

(22) Filed: Feb. 22, 2021

Related U.S. Application Data
(60) Provisional application No. 62/980,114, filed on Feb. 21, 2020.

(51) Int. Cl. G10H 3/14; G10D 13/065; G10D 13/10

(52) U.S. Cl. CPC G10H 3/146; G10D 13/26; G10D 13/065

(57) ABSTRACT

An apparatus, system, and method provide hi-hat control for use as an electronic controller for a drum/cymbal hi-hat instrument. The hi-hat controller is an interface for field mounting, e.g., retrofit, for use with existing hi-hat foot pedals to provide a seamless conversion of an acoustic hi-hat foot pedal into an input device for use with electronic drum modules and other signal generating devices.

### CROSS-REFERENCE TO RELATED APPLICATION AND CLAIM OF PRIORITY

The present application claims priority to U.S. Provisional Patent Application 62/980,114, entitled HI-HAT CONTROLLERS, filed Feb. 21, 2020, which is incorporated herein in the entirety.

### FIELD OF THE INVENTION

The field of the invention is electronic instrument triggers. Specifically, the field of the invention relates to electronic controllers and triggers for hi-hat cymbals and associated foot pedal accessories.

### BACKGROUND

The background description includes information that may be useful in understanding the present invention. It is not an admission that any of the information provided herein is prior art or relevant to the presently claimed invention, or that any publication specifically or implicitly referenced is prior art.

In the past few decades, drum triggers have increasingly been used with acoustic drums for live performances and studio recordings. In many instances, drum triggers can overcome potential problems with using microphones and can allow a drummer to have more control over the sound of the drum. In effect, the addition of a drum trigger to an acoustic drum converts the acoustic drum to an electric drum pad. A typical percussion acoustic drum kit includes a snare drum, one or more tom drums, one or more kick drums, and a set of cymbals including a hi-hat cymbal. Triggering drums, e.g., through head, requires different techniques that triggering cymbals and especially hi-hat cymbals, presenting complications in arriving at effective field mountable retro fit solutions to allow traditional acoustic drum sets o be electronically triggered for pick-up and/or amplification such as for live performances.

There are several existing varieties of drum triggers. A first type of prior art drum trigger involves a tension arm that is mounted on the rim of a drum using a lug or clamp mount mechanism. Additionally, the piezoelectric transducer commonly used in these triggers may begin to degrade or wear out quickly because it is placed in high-stress direct contact with the drumhead. The very design of prior art triggers causes the triggers to suffer from the aforementioned problems. Prior art trigger designs are also ineffective when used on certain components of a drum kit, such as hi-hat cymbals and crash cymbals.

A drum module is an electronic device that interprets an input and produces as an output a sound or other electronic output. For prior art triggers, the drum module will need to be specifically tuned to not only the type of trigger, but the manner in which the trigger is installed and the type of instrument on which the trigger is installed. The configuration must also take into account other external conditions at the time of configuration. The exact same trigger may need different configuration settings each time the trigger is set up for use.

The field of electronic instrument triggering is comprised of numerous ways to trigger an electronic module by the playing of an instrument, including percussion instruments, including cymbal instruments. Systems and method for musical instrument triggering include: U.S. patent application Ser. No. 16/532,453, entitled INSTRUMENT TRIGGER AND INSTRUMENT TRIGGER MOUNTING SYSTEMS AND METHODS (Suitor), filed Aug. 5, 2019; U.S. patent application Ser. No. 15/456,471, entitled HANDHELD ELECTRONIC MUSICAL PERCUSSION INSTRUMENT (Suitor), filed Mar. 10, 2017, which claims benefit of U.S. Provisional Patent Application 62/306,306, entitled HANDHELD ELECTRONIC MUSICAL PERCUSSION INSTRUMENT (Suitor), filed Mar. 10, 2016, and which also claims benefit of priority and is a continuation-in-part of pending U.S. patent application Ser. No. 15/433,990, entitled MAGNETICALLY SECURED CYMBAL TRIGGER AND CHOKE ASSEMBLY (Suitor), filed Feb. 15, 2017, which claims priority to U.S. Provisional Patent Application 62/295,483, entitled MAGNETICALLY SECURED CYMBAL TRIGGER AND CHOKE ASSEMBLY (Suitor), filed Feb. 15, 2016; which claims benefit of priority and is a continuation-in-part of pending U.S. Utility patent application Ser. No. 14/988,570, entitled MAGNETICALLY SECURED INSTRUMENT TRIGGER (Suitor), filed Jan. 5, 2016, which claims priority to U.S. Provisional Patent Application 62/259,047, entitled PIEZOELECTRIC INSTRUMENT TRIGGER (Suitor), filed Nov. 23, 2015, which also claims priority to U.S. Provisional Patent Application 62/100,041, entitled DUAL SIDED MAGNETIC DRUM TRIGGER (Suitor), filed Jan. 5, 2015; which also claims the benefit of U.S. Provisional Patent Application 62/448,388, entitled MAGNETICALLY SECURED INSTRUMENT TRIGGER AND INSTRUMENT TRIGGER MOUNTING SYSTEMS AND METHODS (Suitor), filed Jan. 19, 2017; and which also claims benefit of U.S. Provisional Patent Application No. 62/448,953, entitled MAGNETICALLY SECURED INSTRUMENT TRIGGER AND INSTRUMENT TRIGGER MOUNTING SYSTEMS AND METHODS (Suitor), filed Jan. 20, 2017; each of which is incorporated by reference in their entirety.

The evolution of electronic drums has been in a constant state of improvement. Today's drummers have the benefit of decades long enhancements to drum modules that make the sound of an electronic drum kit hard to distinguish from a real acoustic drum set. Many drummers take things a step further and use computer-based triggering.

Thus, there is a need for an instrument trigger or controller that is compatible with conventional acoustic cymbals. Additionally, there is a need for an improved electronic controller for use with acoustic or electric hi-hat cymbals.

There is a need for a versatile hi-hat pedal control device adapted for use in retrofitting a wide range of existing hi-hat foot pedal configurations to enable users to easily convert a standard hi-hat foot pedal for use in electronically triggering a hi-hat cymbal and for connecting same to an electronic control module for reproducing sounds associated with and derived from the mechanical action of the user when playing a drum set and manipulating the hi-hat foot pedal.

### SUMMARY OF THE INVENTION

The present invention generally relates to electronic musical instrument triggering, control, and sound reproduction. More specifically, the present invention relates to an electronic controller for a hi-hat cymbal adapted to generate a signal as an input to a drum module for processing and generation of output signals.

The present invention provides for an improvement over existing systems for electronic drumming with traditional acoustic hi-hats that required a separate pedal or extensive modification of an existing hi-hat stand pedal. The present invention may be easily installed and removed from a hi-hat stand to provide for simple transformation of a traditional acoustic hi-hat and stand into an electronically triggered and controlled hi-hat.

The present invention may also be used in combination with low volume cymbals and low volume cymbal triggers. Low volume cymbals often are metallic and characterized as perforated with a patterned set of openings or perforations throughout the body of the cymbal. Low volume cymbals do not produce the sound volume when struck that traditional cymbals produce and are often used in practice settings or in situations where less sound volume is desired. Triggering low volume cymbals enables uses to capture the striking of the cymbal and generate signals for delivery to “drum” modules or the like to then generate signals which may be amplified or otherwise used to generate audible sounds. In this manner, the triggering of the low volume cymbals allows users to create whatever sound volume they desire and through modules allows users to customize or select a desired effect or signature sound, e.g., crash, ride, splash, sizzle, bell, china, clash, gong, hi-hat, etc. Through the module the user may also select a desired “kit” or style associated with a performance, e.g., jazz, rock, pop, blues, etc. Additional triggering may be used on the drum kit, e.g., snares, toms, bass, etc., for an overall kit triggering system.

In one embodiment, the present invention provides an electronic musical instrument controller comprising a housing having a top and a bottom, and a position sensor. The position sensor may be a plunger or pin type position sensor comprising means for changing the resistance provided by the sensor based on the position of the plunger or pin. The controller may further comprise an input jack which may be a ⅛ inch mono TS input jack or a TRS input jack. The present invention may further comprise an instrument module, which may be a drum module, for providing an input signal that may be modified by the position sensor. The present invention may further comprise modifying the input signal from the instrument module based on the position of a pedal of a hi-hat stand. The present invention may further comprise securing means, which may be a set of magnetic mounts or a set of mounting slots, for securing the controller to a hi-hat stand. The present invention may further comprise wherein a tip of a plunger of the position sensor is positioned in physical contact with a pedal of a hi-hat stand such that when the pedal is depressed the plunger of the position sensor moves correspondingly with the depression of the pedal.

In a first embodiment, the present invention provides an electronic musical instrument hi-hat controller input device comprising: a housing adapted to be mounted to a foot pedal apparatus used to operate a hi-hat cymbal; a position sensor disposed within the housing and having a displaceable element extending from the housing and configured to make contact with a bottom surface of the foot pedal during operation of the foot pedal; and a jack comprising a plug/receptacle at one end for connecting to a cable associated with an electronic control module and having wiring connected to connectors of the position sensor.

The first embodiment hi-hat controller input device may be further characterized in one or more of the following manners: wherein the position sensor is a resistive element and the displaceable element provides an effective range of resistance value; wherein the displaceable element is a linear element and provides a range of resistance from about 0 ohms to about 10 ohms; wherein the position sensor is disposed in the housing so that the displaceable element is essentially orthogonal to the bottom surface of the oppositely facing pedal and the movement of the displaceable element is essentially linear and in an axis normal to a plane common to the foot pedal; wherein the position sensor is a plunger or pin type position sensor comprising means for changing the resistance provided by the sensor based on the position of the plunger or pin; wherein the operation of the position sensor is adapted to permit connection of the input jack with either a ⅛ inch mono TS input jack or a TRS input jack; being adapted to connect with an instrument drum module, for providing an input signal that may be modified by the position sensor; wherein the input signal from the instrument module is based on the position of a pedal of a hi-hat stand; further comprising securing means, which may be a set of magnetic mounts or a set of mounting slots, for securing the controller to a foot pedal accessory of a hi-hat stand; wherein the displaceable element is positioned to be in physical contact with a pedal of a hi-hat stand such that when the pedal is depressed the displaceable element moves correspondingly with the depression of the pedal; further comprising at least one magnet fixed to the housing and adapted to be magnetically attracted to a magnetically receptive pedal plate to maintain secure but removable fixation of the housing to the foot pedal base during operation of the hi-hat.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIGS. 1-5 provide various views and diagrams of an electronic hi-hat controller according to a first embodiment of the present invention using a plunger or pin-type potentiometer-based position sensing configuration.

FIGS. 6-11 provide various views and diagrams of a digital electronic hi-hat controller according to a second embodiment of the present invention using an accelerometer-based position sensing configuration.

FIGS. 12-17 provide various views and diagrams of an electronic hi-hat controller according to a third embodiment of the present invention using a plunger or pin-type potentiometer-based position sensing configuration.

### DETAILED DESCRIPTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

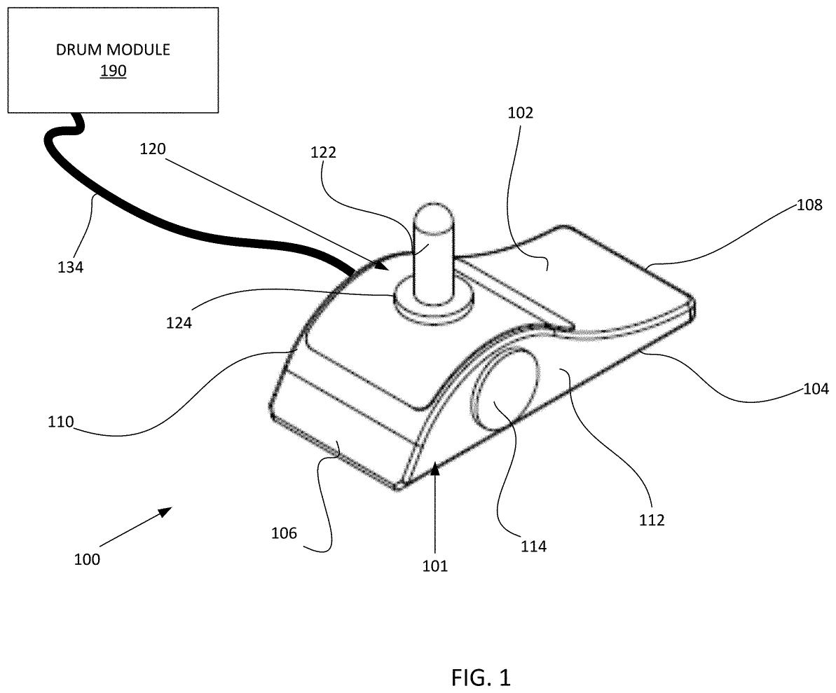

With reference to FIG. 1, a front isometric view of an electronic hi-hat controller 100 is provided. The hi-hat controller 100 comprises a body or housing 101 having a top 102, bottom 104, front 106, rear 108, first or left side 112, and second or right side 110. An access opening or plug 114 may be disposed on one or both sides 110 and 112. The top 102 of the housing 101 is generally curvilinear in shape rising to a high point near the front 106 and then gradually sloping down and tapering off towards the back 108.

At the center of the highest point of the top 102 is disposed a position sensor 120. The position sensor 120 may be a TT ELECTRONICS Model 404 Series position sensor or similar sensor, potentiometer, or other suitable analog or digital position sensing means. The pin or plunger 122 of the position sensor 120 is fixed in place by a washer or grommet 124 which may be a plastic or rubber washer or grommet for positioning the plunger 122 in the proper position while freely permitting the plunger 122 of the position sensor 120 to move up and down in a Y-axis in normal operation.

The housing 101 of the controller 100 may be 1.75 inches wide from one side 110 to the opposite side 112, 2.5 inches high from the bottom 104 to the top of the plunger 122, and 5.2 inches in length from the front 106 to the back 108. The total travel distance of the plunger 122 is 1.4 inches from a fully extended position to a fully depressed or engaged position. The total weight of the controller 100 may be 2.7 oz. The housing may be comprised of plastic, bent or stamped sheet metal, cast metal, or milled metal and the metal may be steel or aluminum or another suitable material. The housing 101 may also comprise means for securing the controller 100 to a hi-hat stand, such as the stand 150 shown in FIG. 5. A set of mounting slots 116 and 117 may be disposed on both sides 110 and 112 to provide for the controller 100 to be installed in a standard hi-hat stand. For non-standard stands, a set of magnets or magnetic mounts 118 and 119 are provided on the bottom 104 of the housing 101 for hi-hat stands having a ferrous bottom plate. The magnets 118 and 119 may have a pull force of 12 lbs. each. The shape of the housing 101 of the controller 100 and the mounting slots 116 and 117 or magnetic mounts 118 and 119 provide for the controller 100 to withstand forces of 60-80 lbs. in normal operation.

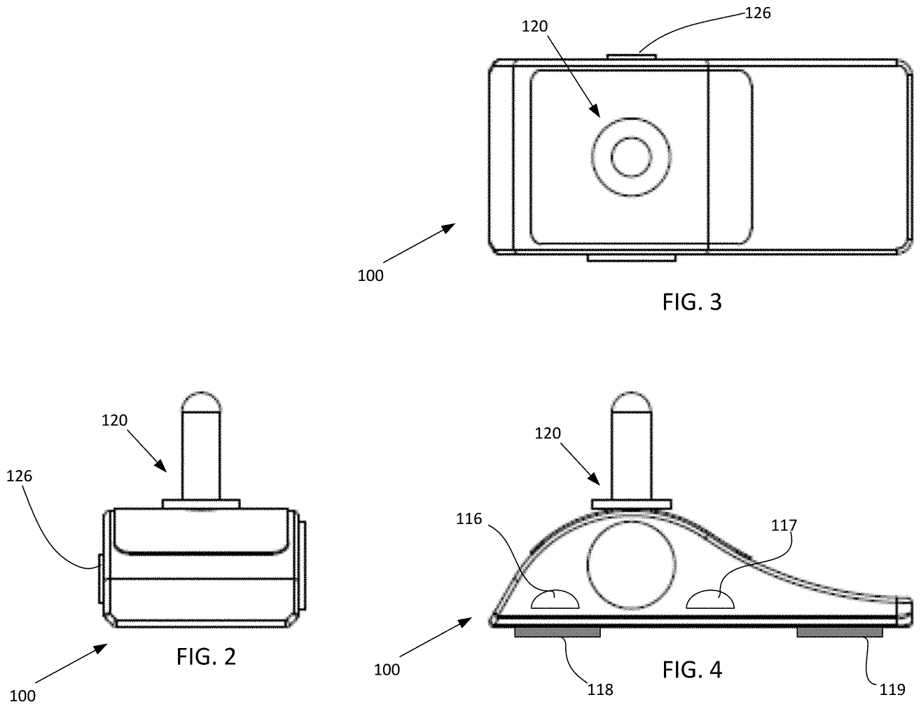

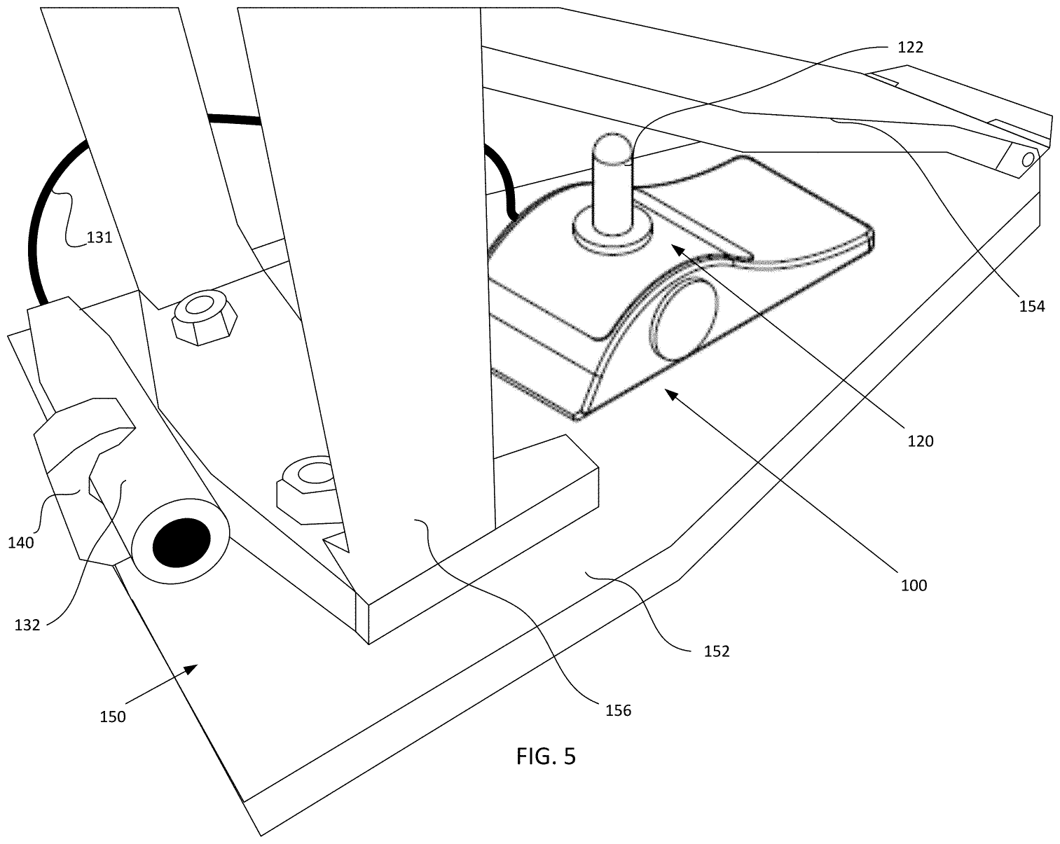

The controller 100 is passively powered and does not require an additional power source or an internal source of power, such as a battery. Power is provided via a 3.5 mm or ⅛ inch mono input jack, such as the jack 132 connected by cable 134 in FIG. 5 to the port 126 shown in FIGS. 2 and 3. The cable 134 connects and provides electrical communication between the controller 100 and a drum module 190, which may be any suitable drum module or music synthesizer module.

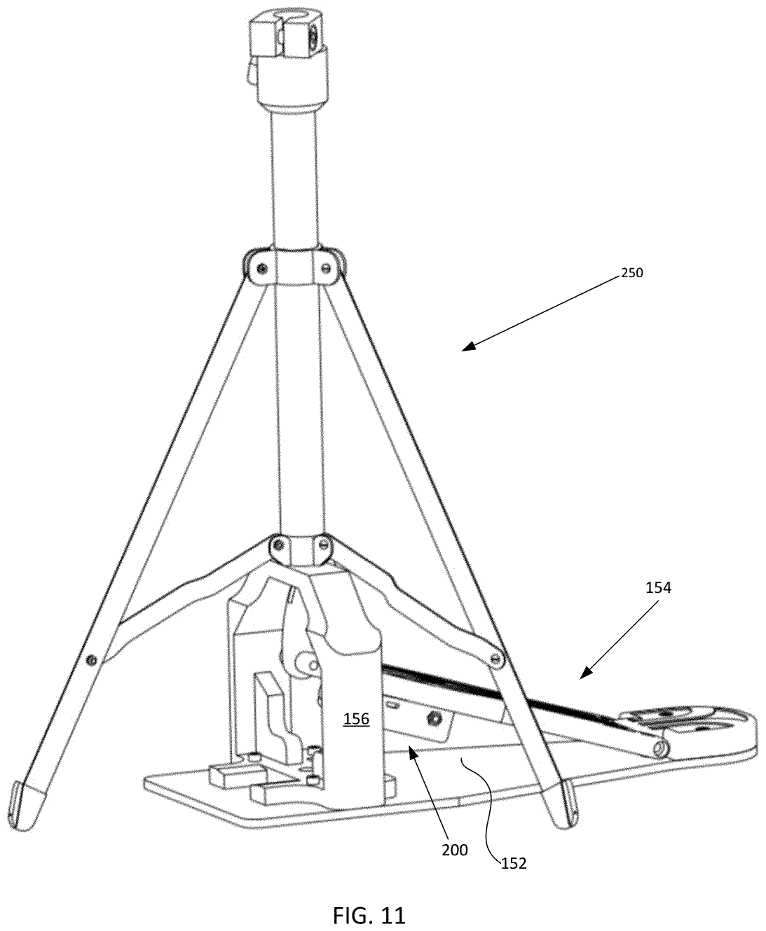

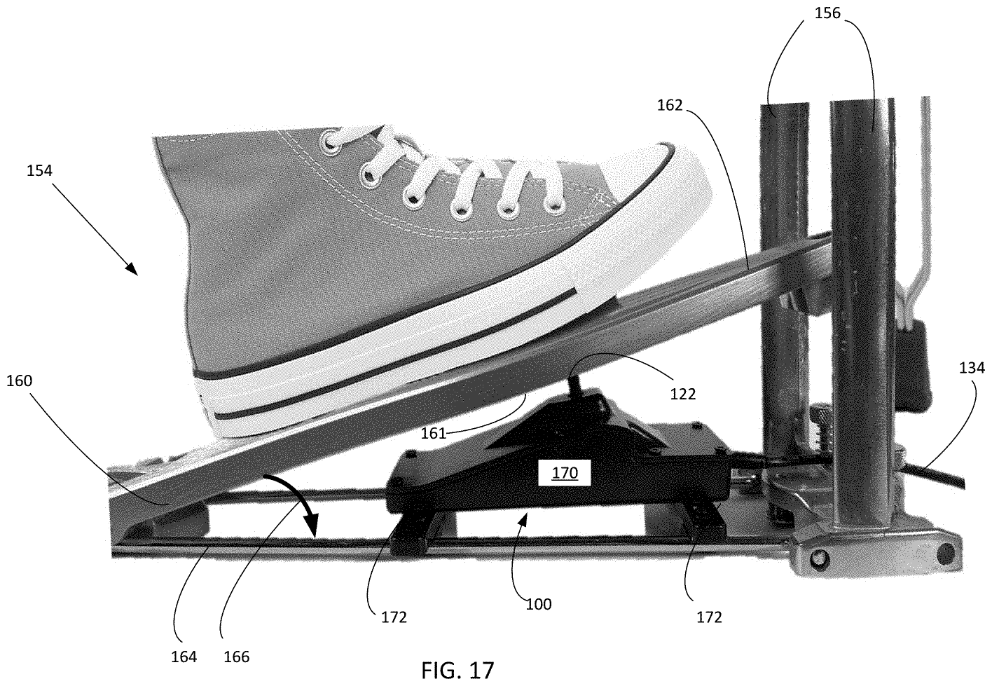

With reference now to FIG. 5, a perspective view of a controller 100 installed on a hi-hat stand 150 is provided. In electronic drumming using an acoustic drum kit equipped with instrument triggers or with an electronic drum kits, a drum module requires input from a hi-hat controller to create, modify, or adjust the variations of the open and closed sounds for a hi-hat trigger. The traditional method of doing this is with a stand-alone electronic foot pedal. By using their foot on the pedal a drummer can control the hi-hat sound from open to closed. The variations in-between (i.e., between fully open and fully closed) are also controlled in the same way. This traditional type of pedal does not work with a standard hi-hat stand for an acoustic hi-hat cymbal. Using a two-piece electronically triggered cymbal requires a standard hi-hat stand to provide for the two-piece cymbals to physically open and close. The controller 100, which may be referred to as a Magnatrack Remedy Hi-Hat Controller One (HC-1), works under the pedal 154 of a used with a standard hi-hat stand 250 (see FIG. 11) and is disposed on the bottom plate 152 of the pedal assembly of stand 250. Bottom plate 152 may be a flat metal base or more often is a parallel or “radius” rod configuration as shown in FIG. 17. Installing and using the controller 100 with an acoustic hi-hat stand 150 provides the feel to a drummer or user of playing traditional acoustic hi-hats while providing for control of electronically triggered acoustic hi-hats. The controller 100 provides for a user to use their foot on the standard pedal associated with hi-hat stand 250 pedal 154. A user or drummer can control the hi-hat sound from fully open to fully closed, while at the same time physically allowing the two-piece hi-hat cymbal to open and close.

The controller 100 may be secured to the base or plate 152 of the pedal base portion 150 of the hi-hat stand 250 by magnetic mounts 118 and 119, or by mounting slots 116 and 117 where the pedal base portion 150 may have corresponding tabs for mounting. The cymbal frame portion or support casting 156 supports the acoustic hi-hat cymbals controlled by the pedal 154 of the stand 250. A clip or mount 140 secures the jack 132 to the stand 150 and a cable 134 connects the jack 132 to the controller 100.

When installed, the tip of the plunger 122 of the position sensor 120, when the plunger 122 is fully extended, should be in physical contact with the pedal 154 when the pedal 154 is in a neutral or resting position. When the pedal 154 is depressed in normal operation of the acoustic hi-hat cymbal on the stand 150, the plunger 122 is correspondingly depressed. The depressing of the plunger 122 changes the resistance of the signal provided by the module 190 such that the module 190 may then corresponding generate, alter, or modify a sample sound, such as a triggered hi-hat sound, generated by the module 190 based on the signal modified by the controller 100.

Installing the controller 100 on a stand 150 and modifying the signal provided by the module 190 in this manner provides for a full range of articulation for a hi-hat sample triggered by an instrument trigger on the acoustic hi-hat, modified by the controller 100, and generated by the module 190. This manner of signal modification provides a faster response than pressure-based controllers or “laggy” Hall effect type sensors and provides for traditional operation of an acoustic hi-hat without modification of the hi-hat or stand 150.

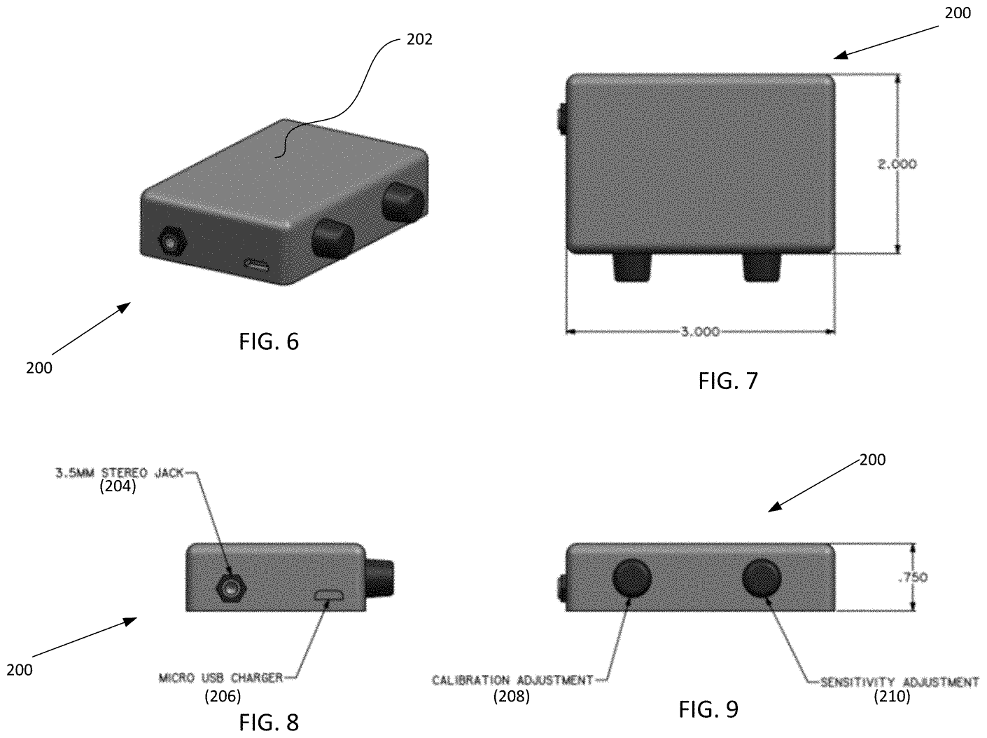

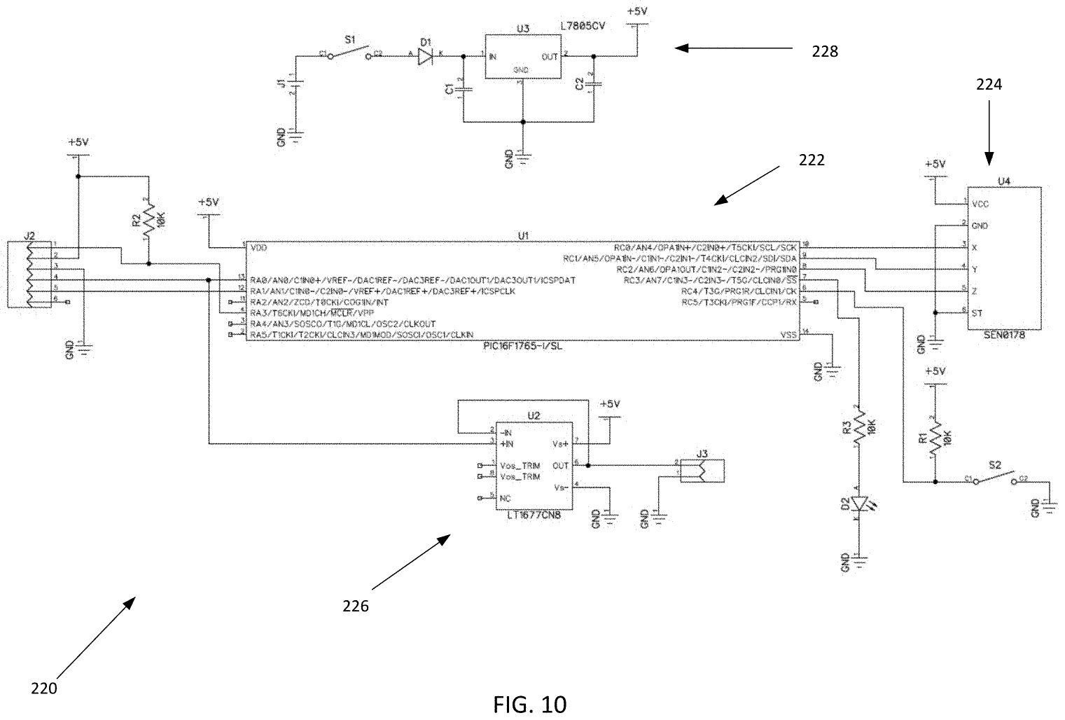

FIGS. 6-11 provide various views and diagrams of a digital electronic hi-hat controller 200 according to an alternative embodiment of the present invention utilizing an accelerometer-based position sensing configuration. Current electronic hi-hat controllers consist of an extra pedal separate from the hi-hat the triggered cymbals are mounted to. This method creates an additional item in an already cluttered footprint for any drummer. The method the pedal uses to send hi-hat articulations is outdated and unreliable. The pedal works like that of a sewing machine providing voltage that is regulated by some analog device capable of measuring and outputting resistance. A lower voltage read by the drum module corresponds to the hi-hat being seen as open. At a greater voltage output the module starts to close the hi-hat's audible articulation until completely closed.

The digital electronic hi-hat controller 200 of the present invention works fluidly with any existing hi-hat stand 250 instead of adding extra unnecessary gear to the drummer's gear footprint. The controller 200 works with an internal accelerometer 224, which may be a four-axis accelerometer such as a SEN0178, to determine the acoustic hi-hat pedal position. Once calibrated by using the controls on the exterior of the case 202 of the controller 200, including the calibration adjustment potentiometer 208 and sensitivity adjustment potentiometer 210, on the unit or by Bluetooth output to an smart phone based application, the drummer simply plays the hi-hats as usual while the unit replicates the natural movement in real-time to include “foot splashes” and “chika” sound synonymous with the acoustic hi-hat.

The controller 200 may be charged via a USB port 206 or other similar charging port, and its output 204, which may be a 3.5 mm stereo jack, may be connected to other devices or modules. The controller 200 may be controlled by an 8-bit controller 222 such as a PIC16F1765 and may comprise an op-amp 226 such as a LT1677CN8, and the voltage may be regulated by a voltage regulator 228 such as a L7805CV. The controller 200 may also comprise a rechargeable battery such as a lithium-ion or nickel-metal-hydride battery.

The controller 200 may be used in a manner similar to the controller 100, such that it may be used with an acoustic hi-hat without modification of the hi-hat stand to provide for natural play and operation of the hi-hat when used with instrument triggers and a drum module or music synthesizer.

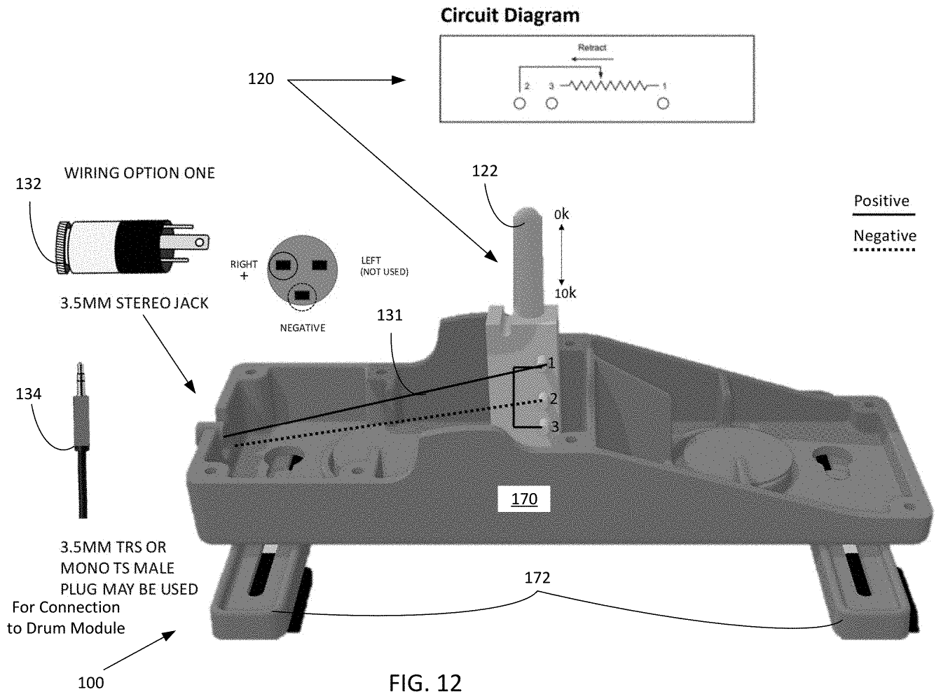

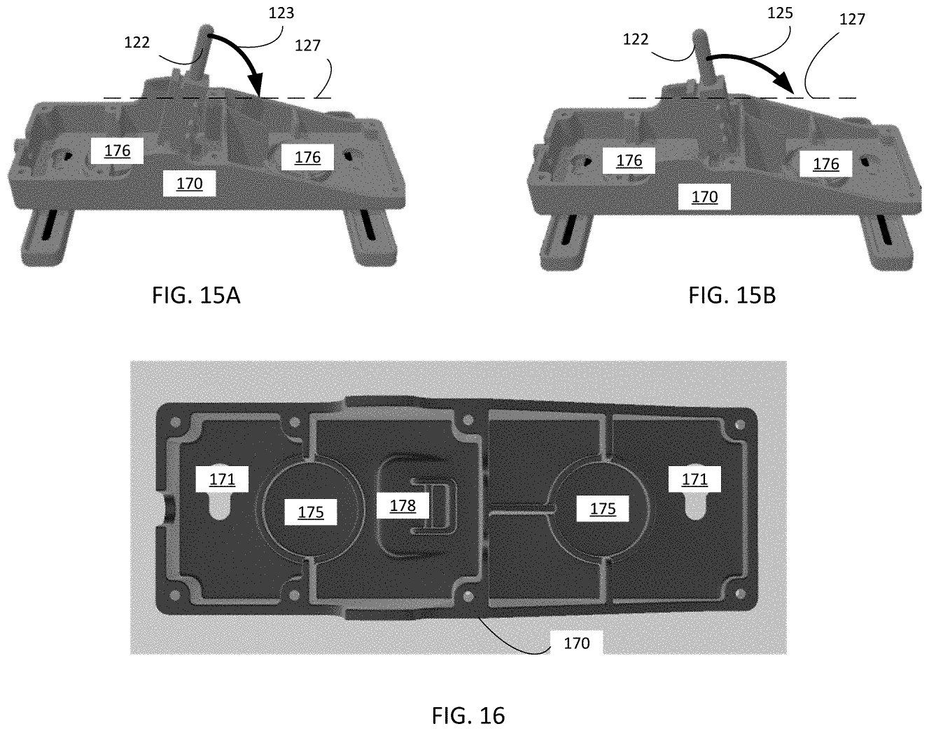

FIGS. 12-17 provide various views and diagrams of an electronic hi-hat controller or signal generator 100 according to a third embodiment of the present invention using a plunger or pin-type potentiometer-based position sensing configuration.

FIG. 12 illustrates a first electronic configuration of an exemplary hi-hat controller according to a third embodiment of the present invention using a plunger or pin-type potentiometer-based position sensor 120 disposed within and supported by housing 170. Sensor or potentiometer 120 includes a linear or plunger or pin type displacement member 122. The sensor or potentiometer 120 may be an active device designed to generate a signal or may be a passive device, such as a resistive element as shown. As shown in this example, and not limiting to the invention, the potentiometer 120 has a range of 0-10 kohms over the range of the linear displacement of plunger 122—as referenced in the circuit diagram with pins 1-3 representing the connection points for the circuit and the internal resistive feature. The tip or top of plunger 122 is positioned and configured to come into contact with the bottom surface 161 of a pedal 154 as shown in FIG. 17. Preferably, and as shown in FIG. 17, the linear movement of the plunger 122 is substantially orthogonal to the bottom surface 161 of the pedal 154 to prevent torque or other unwanted forces from acting on the potentiometer 120 upon the pedal being depressed by a user that could cause premature wearing and damage and potentially suboptimal performance.

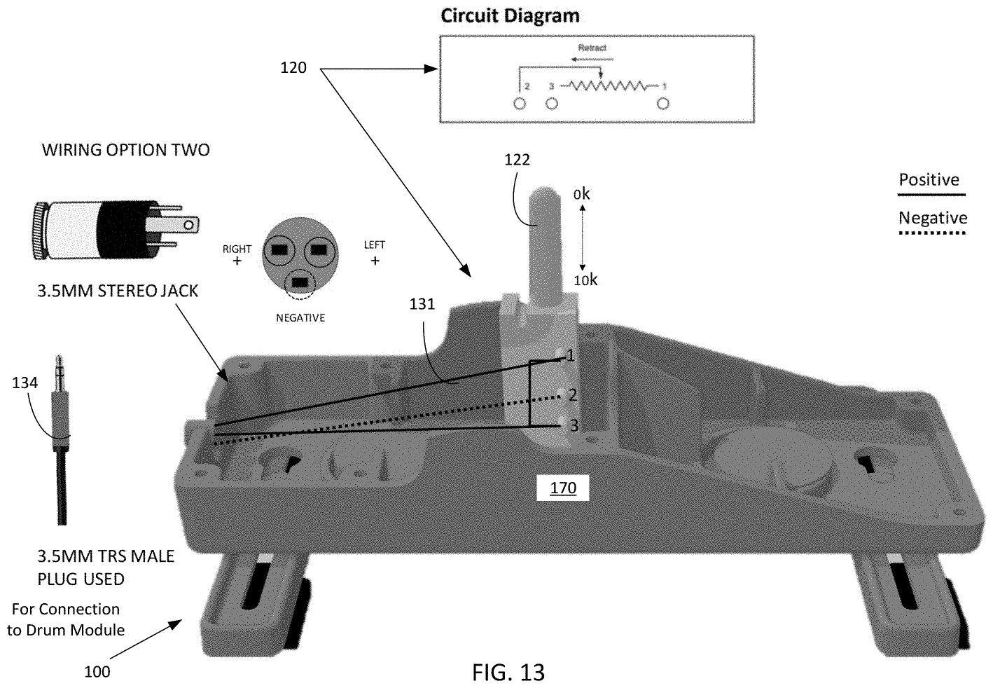

As shown in FIG. 12, the hi-hat controller 100 is set up with a female or receiving 3.5 mm stereo jack 132 fixed onto the housing 170 and internally wired to the potentiometer 120 at connector pins 1-3 via wires 131, with pins 1 and 3 having a jumper cable or element. A male jack 134 is plugged into the receiving jack 132 and is connected at the other end to an electronic drum module or other device associated with generating a signal representative of the hi-hat operation associated with use of pedal 154. In this example, the jack 134 is “universal” in that either a TRS (tip/ring/sleeve—three-wire) jack or a TS (tip/sleeve—two-wire) jack may be used. Certain manufacturers of electronic drum modules may require a particular set up and FIG. 13 illustrates an alternative version of the hi-hat controller 100 having alternative wiring as shown and for use with a TRS plug or jack 134.

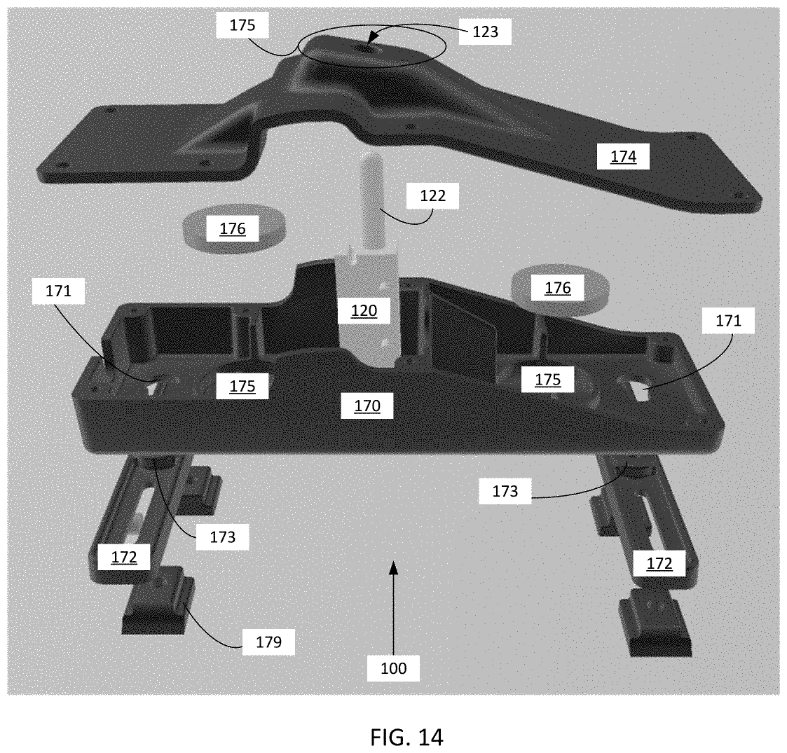

FIG. 14 is an exploded view of the hi-hat controller 100 of FIGS. 12-13 having a housing or base portion 170, a top or cover portion 174, leg brackets 172, and feet 179. As shown, housing 170 include lateral slots or recesses and receiving bores 171 through which are received mounting protrusions or nubs or shoulders 173. In this manner, the housing is mounted to a set of parallel or radius rods of a pedal base by means of affixing leg brackets 172 to the parallel rods and positioning the brackets so the nubs 173 align with the bores 171 and the housing may be positioned and twisted in place.

Some pedal accessories use a metal base plate rather than the radius rod configuration. Additionally, magnets 176, preferably high strength neodymium or other rare earth magnets are received in recesses 175 (FIG. 16) and may be used to hold the controller in place on a steel base plate without the need for the bracket and leg portions. In either configuration, the housing, and therefore the plunger 122, may be moved forward or rearward, e.g., along the length of radius rods 164, to provide adjustability to the desired placement of the potentiometer based on user preferences. Support 178 may be configured to permit adjustment of the relative angle of potentiometer 120 relative to plane 127.

As shown, the top portion 174 includes an inclined portion 175 having a hole 123 through which plunger 122 is received. Potentiometer 120 is received in a supporting recess or cavity or support 178 (FIG. 16) such that the plunger 122 is angled relative to ground and is perpendicular or orthogonal to the pedal plate as shown in FIG. 17.

While the invention has been described by reference to certain preferred embodiments, it should be understood that numerous changes could be made within the spirit and scope of the inventive concept described. In implementation, the inventive concepts may be automatically or semi-automatically, i.e., with some degree of human intervention, performed. Also, the present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. An electronic musical instrument hi-hat controller input device comprising:
a housing adapted to be mounted to a foot pedal apparatus used to operate a hi-hat cymbal;
a position sensor disposed within the housing and having a displaceable element extending from the housing and configured to make contact with a bottom surface of the foot pedal during operation of the foot pedal; and
a jack comprising a plug/receptacle at one end for connecting to a cable associated with an electronic control module and having wiring connected to connectors of the position sensor.

2. The hi-hat controller input device of claim 1 wherein the position sensor is a resistive element and the displaceable element provides an effective range of resistance value.

3. The hi-hat controller input device of claim 2, wherein the displaceable element is a linear element and provides a range of resistance from about 0 ohms to about 10 ohms.

4. The hi-hat controller input device of claim 1, wherein the position sensor is disposed in the housing so that the displaceable element is essentially orthogonal to the bottom surface of the oppositely facing pedal and the movement of the displaceable element is essentially linear and in an axis normal to a plane common to the foot pedal.

5. The hi-hat controller input device of claim 1, wherein the position sensor is a plunger or pin type position sensor comprising means for changing the resistance provided by the sensor based on the position of the plunger or pin.

6. The hi-hat controller input device of claim 1, wherein the operation of the position sensor is adapted to permit connection of the input jack with either a ⅛ inch mono TS input jack or a TRS input jack.

7. The hi-hat controller input device of claim 1 being adapted to connect with an instrument drum module, for providing an input signal that may be modified by the position sensor.

8. The hi-hat controller input device of claim 7, wherein the input signal from the instrument module is based on the position of a pedal of a hi-hat stand.

9. The hi-hat controller input device of claim 1 further comprising securing means, which may be a set of magnetic mounts or a set of mounting slots, for securing the controller to a foot pedal accessory of a hi-hat stand.

10. The hi-hat controller input device of claim 1, wherein the displaceable element is positioned to be in physical contact with a pedal of a hi-hat stand such that when the pedal is depressed the displaceable element moves correspondingly with the depression of the pedal.

11. The hi-hat controller input device of claim 1 further comprising at least one magnet fixed to the housing and adapted to be magnetically attracted to a magnetically receptive pedal plate to maintain secure but removable fixation of the housing to the foot pedal base during operation of the hi-hat.
